(19) United States
(12) Patent Application Publication
(10) Pub. No.: US 2022/0366330 A1
(43) Pub. Date: Nov. 17, 2022

(54) METHOD AND SYSTEM FOR DETERMINING A PREDICTED OPERATION TIME FOR A MANUFACTURING OPERATION USING A TIME PREDICTION MODEL

(71) Applicant: Ford Global Technologies, LLC, Dearborn, MI (US)

(72) Inventors: Lijun Wang, Canton, MI (US); Derrick Boroski, Livonia, MI (US); Mohammad Babakmehr, Northbrook, IL (US)

(73) Assignee: Ford Global Technologies, LLC, Dearborn, MI (US)

(21) Appl. No.: 17/318,130

(22) Filed: May 12, 2021

(51) Int. Cl. G06Q 10/06; G06Q 10/04; G05B 19/418

(52) U.S. Cl. CPC G06Q 10/0633; G06Q 10/04; G05B 19/41865; G05B 19/4183; G05B 19/41875

(57) ABSTRACT

A method of defining a manufacturing operation for a workstation includes providing a selected manufacturing operation record from among a plurality of manufacturing operation records for a selected manufacturing operation to be executed in the workstation. The method further includes extracting, by a process allocation system, process element data for a plurality of process elements associated with the selected manufacturing operation record. The process element data includes a textual description of the respective process element and a process time. The method further includes determining, by the process allocation system, a predicted operation time for the selected manufacturing operation based on the process element data and a time prediction model, where the time prediction model is a trained model recognizing sequential patterns among the plurality of process elements of the selected manufacturing operation.

### FIELD

The present disclosure relates to a method and system determining an operation time for a manufacturing operation.

### BACKGROUND

The statements in this section merely provide background information related to the present disclosure and may not constitute prior art.

Designing a workstation for a manufacturing operation to be performed by an operator can be a time-consuming process. More particularly, a workstation is generally designed to provide optimal work output, which is influenced by the time it takes the operator to perform the manufacturing operation. In some applications, a manufacturing operation can include multiple steps to be performed in a specific order. Each step of the manufacturing operation can be associated with a predefined process time. In some instances, the predefined process time is an inaccurate estimate of the length of time needed to perform the step and thus, provides an inaccurate time for performing the overall manufacturing operation.

In some applications, the predefined time is provided as a baseline time, and design engineers adjust the time by employing time consuming work studies and their own expertise to determine an accurate operation time. The additional time and resources employed to obtain the improved operation time can be costly and can become a bottleneck in designing a new workstation or even updating an existing workstation.

These and other issues related to designing workstations are addressed by the present disclosure.

### SUMMARY

This section provides a general summary of the disclosure and is not a comprehensive disclosure of its full scope or all of its features.

The present disclosure provides a method of defining a manufacturing operation for a workstation. The method includes providing a selected manufacturing operation record from among a plurality of manufacturing operation records, wherein the selected manufacturing operation record is indicative of a selected manufacturing operation to be executed in the workstation. The method includes extracting, by a process allocation system, process element data for a plurality of process elements associated with the selected manufacturing operation record, wherein, for a respective process element among the plurality of process elements, the process element data includes a textual description of the respective process element and a process time. The method includes determining, by the process allocation system, a predicted operation time for the selected manufacturing operation based on the process element data and a time prediction model, wherein the time prediction model is a trained model recognizing sequential patterns among the plurality of process elements of the selected manufacturing operation.

In some forms, determining the predicted operation time further includes, for each of the plurality of process elements, parsing, by the time prediction model, terms of the textual description of the process element into one or more tokens. Determining the predicted operation time further includes, for each of the plurality of process elements, determining, by the time prediction model, semantic relationship of textual description based on tokens. Determining the predicted operation time further includes, for each of the plurality of process elements, defining, by the time prediction model, a feature vector for the process element based on the semantic relationship.

In some forms, the method further includes identifying, by the time prediction model, one or more sequential patterns of the one or more feature vectors. The method further includes generating, by the time prediction model, an operation vector indicative of the selected manufacturing operation based on the one or more sequential patterns of the one or more feature vectors, wherein the predicted operation time is determined based on the operation vector.

In some forms, the one or more sequential patterns of the one or more feature vectors is identified using self-attention modeling.

In some forms, the method further includes providing a domain variable data for the selected manufacturing operation, where the domain variable data is indicative of a domain variable that influences time of the selected manufacturing operation, and where the predicted operation time of the selected manufacturing operation is further determined based on the domain variable data.

In some forms, the domain variable data includes data indicative of a tool characteristic related to a tool to be employed at the workstation, a workstation characteristic, or a combination thereof.

In some forms, providing the selected manufacturing operation record from among the plurality of manufacturing operation records further includes identifying the selected manufacturing operation record in a database storing the plurality of manufacturing operation records based on the selected manufacturing operation, wherein the database stores the process element data for the plurality of process elements associated with the selected manufacturing operation.

In some forms, the present disclosure provides a method of defining a manufacturing operation for a workstation. The method includes providing a selected manufacturing operation record from among a plurality of manufacturing operation records and a domain variable data, where the selected manufacturing operation record is associated with a selected manufacturing operation to be executed in the workstation and the domain variable data is indicative of a domain variable that influences time of the selected manufacturing operation. The method includes extracting, by a process allocation system, process element data for a plurality of process elements associated with the selected manufacturing operation from the selected manufacturing operation record, where, for a respective process element among the plurality of process elements, the process element data includes a textual description of the respective process element and a process time. The method includes defining, by a time prediction model of the process allocation system, a feature vector for each of the plurality of process elements based on a semantic relationship of the textual description for the process element. The method includes identifying, by the time prediction model, one or more sequential patterns of the one or more feature vectors of the plurality of process elements. The method includes determining, by the time prediction model, a predicted operation time for the selected manufacturing operation based on the one or more sequential patterns of the one or more feature vectors and the domain variable data.

In some forms, the one or more sequential patterns of the one or more feature vectors are identified using the domain variable data.

In some forms, the method further includes correlating the domain variable data with a numerical value to define domain variable vector, where the predicted operation time for the selected manufacturing operation is determined based on the domain variable vector and the one or more sequential patterns of the one or more feature vectors.

In some forms, the domain variable data includes data indicative of a tool characteristic related to a tool to be employed at the workstation, a workstation characteristic, or a combination thereof.

In some forms, the one or more sequential patterns of the one or more feature vectors is identified using self-attention modeling.

In some forms, providing the selected manufacturing operation from among a plurality of manufacturing operations further includes identifying the selected manufacturing operation record in a database storing the plurality of manufacturing operation records, wherein the database stores the process element data for the plurality of process elements associated with the selected manufacturing operation.

In some forms, the presents disclosure includes a system for designing a workstation at which a manufacturing operation is to be performed. The system includes a database, a processor, and a nontransitory computer-readable medium including instructions that are executable by the processor. The database is configured to store a plurality of manufacturing operation records for a plurality of manufacturing operations, where each of the manufacturing operations is defined by a plurality of process elements provided in sequence, each of the manufacturing operation records includes process element data for each of the plurality of process elements, and where the process element data for a respective process element includes a textual description of the respective process element and a process time. The instructions include obtaining a selected manufacturing operation record from among the plurality of manufacturing operation record from the database for a selected manufacturing operation. The instructions include extracting the process element data from the select manufacturing operation record. The instructions include determining a predicted operation time for the selected manufacturing operation based on the process element data and a time prediction model, where the time prediction model is a trained model recognizing sequential patterns among the plurality of process elements for the selected manufacturing operation.

In some forms, the instructions further include, for each of the plurality of process elements of the selected manufacturing operation parsing, by the time prediction model, terms of the textual description of the respective process element data into one or more tokens. The instructions further include determining, by the time prediction model, semantic relationship of textual description based on the one or more tokens. The instructions further include defining, by the time prediction model, a feature vector for the respective process element based on the semantic relationship.

In some forms, the instructions further include identifying, by the time prediction model, one or more sequential patterns of the one or more feature vectors. The instructions further include generating, by the time prediction model, an operation vector indicative of the selected manufacturing operation based on the one or more sequential patterns of the one or more feature vectors, where the predicted operation time is determined based on the operation vector.

In some forms, the one or more sequential patterns of the one or more feature vectors is identified using self-attention modeling.

In some forms, the instructions further includes obtaining a domain variable data for the selected manufacturing operation, where the domain variable data is indicative of a domain variable that influences time of the selected manufacturing operation, and where the predicted operation time of the selected manufacturing operation is further determined based on the domain variable data.

In some forms, the domain variable data includes information related to a tool to be employed at the workstation, a dimension of the workstation, an operation characteristic of the tool to perform the process element, or a combination thereof.

In some forms, the instructions further include correlating the domain variable data with a numerical value to define domain variable vector, wherein the predicted operation time for the selected manufacturing operation is determined based on the domain variable vector and the one or more sequential patterns of the one or more feature vectors.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates an example of a workstation in a manufacturing facility in accordance with the present disclosure;

FIG. 2 is a block diagram of a system having a process allocation system for defining a manufacturing operation in accordance with the teachings of the present disclosure;

FIG. 3 illustrates an example of manufacturing operation records in accordance with the teachings of the present disclosure;

FIG. 4 is a block diagram of a time prediction model of the process allocation system in accordance with the teachings of the present disclosure;

FIG. 5 is a flowchart of a manufacturing prediction routine in accordance with the teachings of the present disclosure; and

FIG. 6 is a flowchart of another manufacturing prediction routine in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

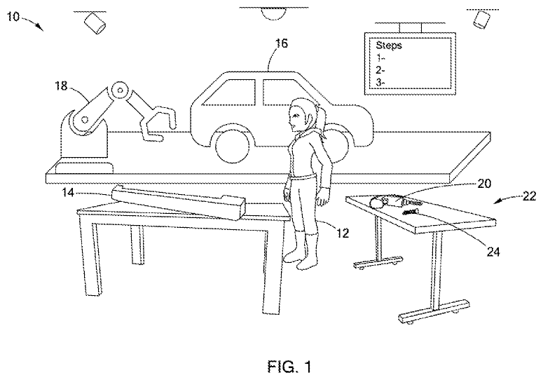

Referring to FIG. 1, a manufacturing facility includes a workstation 10 in which a human operator 12 performs one or more manufacturing operations. A manufacturing operation is defined by one or more steps to be performed in a predefined order or sequence. As an example, in the workstation 10, the operator 12 assembles a workpiece, such as a bumper 14, onto a vehicle 16 with the assistance of a robot 18 that moves and locates the bumper 14 to the vehicle 16. The steps to be performed by the operator may include: (1) obtaining a power tool 20 from a staging area 22; (2) obtaining two fasteners 24 from the staging area 22; (3) securing the two fasteners 24 to the vehicle 16 via the power tool 20; and (4) placing the power tool 20 at the staging area 22. The time it takes the operator 12 to perform the manufacturing operation having the defined steps can vary based on various factors such as, but not limited: size of the workstation which influences distance operator is to walk between, for example, the vehicle and staging area; number of staging areas employed to house tool, fasteners, and other objects to be used in the manufacturing operation; characteristics of the tool being used; number of fasteners to be secured (e.g., instead of two fasteners, operator is to install four fasteners); and the operators ability to combine steps (e.g., in the example of FIG. 1, the operator may combine steps 1 and 2 since the tool 20 and fasteners 24 are provided at the same staging area 22).

When defining a workstation in a manufacturing facility, engineers may select manufacturing operations from among multiple manufacturing operations stored in a database, where each manufacturing operation is defined by one or more sequential steps or, in other words, process elements. In one example, the engineers may select one or more manufacturing operations from a complete list of manufacturing operations to build a vehicle. Each process element is associated with a predefined process time, and the sum of the predefined process times provides a predefined operation time to perform the manufacturing operation. However, as provided above, even though two workstations are configured to perform the same manufacturing operation, the actual operation time can be different. In one example the actual operation time can differ from the predefined process time because one or more steps can be combined, differences between workstations, and/or inaccurate initial estimates.

The present disclosure provides a process allocation system for defining a manufacturing process in a workstation. More particularly, for a selected manufacturing operation(s), the process allocation system determines a predicted operation time for the selected manufacturing operation using a time prediction model, which is a trained model that recognizes dependency patterns between sequential process elements defining the selected manufacturing operation (i.e., recognizes the relationship between process elements which can influence the operation time). In addition to data related to the process elements, the time prediction model may also be configured to determine the predicted operation time using data related to domain variables that are provided as external factors that influence the operation time. As described herein, with the time prediction model, the process allocation system employs data related to the process elements of the manufacturing operation and the domain variables to obtain an operation time that take into account the sequential relationship of the process elements and external factors, both of which influence operation time.

As used herein, a manufacturing operation is defined by one or more process elements, which are steps provided in sequential order for performing the manufacturing operation.

As used herein, domain variable data is data related to defined domain variables that influence the operation time of the manufacturing operation. In one form, domain variables are identified external factors that can influence the operation time. Non-limiting examples of domain variables includes: tool characteristics that provides details of tool(s) to be employed in the workstation such as make, model, power requirement, and/or torque; workstation characteristics related to dimensions of the workstation, layout of the workstation (e.g., placement of staging areas, workpieces, among other objects to be used by the operator); quantity of components to be obtained; type of parts to be assembled; commodity type; and/or manufacturing process types.

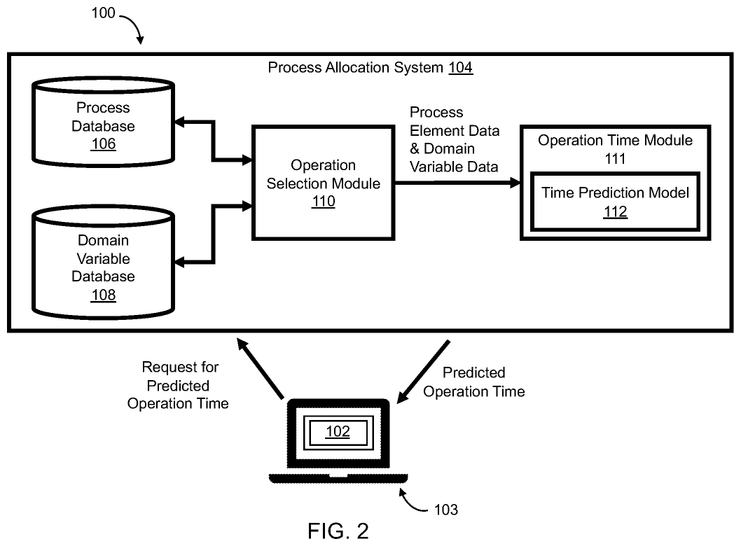

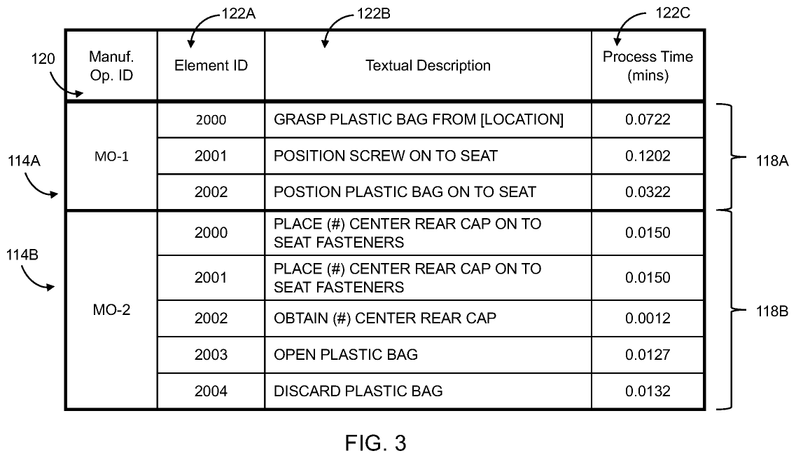

Referring to FIGS. 2 and 3, an example system 100 for designing a workstation to be employed for performing one or more manufacturing operations is provided. In one form, the system 100 may be integrated as a subsystem into one or more other existing manufacturing systems for building a vehicle such as an existing process allocation system. In one form, the system 100 includes a manufacturing design (MD) portal 102 and a process allocation system 104. The MD portal 102 is an interface to provide a user access to the process allocation system 104. More particularly, as provided herein, the process allocation system 104 is configured to provide a predicted operation time for a selected manufacturing operation to be performed by an operator in the workstation. Accordingly, via the MD portal 102 and the process allocation system 104, the user selects one or more manufacturing operations to be performed at the workstation and, in some variations, provides domain variable data for the manufacturing operations. In one form, the MD portal 102 is accessible via a computing device 103 that is in communication with the process allocation system 104 via, for example, the internet and/or a communication network. The computing device 103 may include a desktop computer, a laptop, a smartphone, a tablet computer, or the like.

In one form, the process allocation system 104 includes a process database 106, a domain variable database 108, an operation selection module 110, and an operation time module 111 having a time prediction model 112. It should be understood that the modules and the databases (e.g., a repository, a cache, and/or the like) of the process allocation system 104 may be positioned at the same location or distributed at different locations (e.g., at one or more edge computing devices) and communicably coupled accordingly.

The process database 106 is configured to store a plurality of manufacturing operation records for a plurality of manufacturing operations available for selection. In one example, the plurality of manufacturing operation records is representative of a complete list of manufacturing operations to build a vehicle. Each of the manufacturing operation records provides process element data for each process element defined for a manufacturing operation. In one form, the process database 106 associates each manufacturing operation record with a manufacturing operation identification (ID), and the process element data includes, for example, an element ID, a textual description of the process element, and a process time for the process element.

As an example, FIG. 3 illustrates manufacturing operation records stored in the process database 106. In the example, manufacturing operation records 114A and 114B (collectively “manufacturing operation records 114”) are each provided with a unique manufacturing operation ID 120 (“Manuf. Op. ID” in FIG. 3), such as “MO-1” and “MO-2.” Each manufacturing operation record 114 provides a plurality of process elements associated with a respective manufacturing operation in sequential order (i.e., the order in which the process elements are to be performed by the operator). For example, manufacturing operation record 114A includes three process elements 118A that provides that the operator: grasp a plastic bag from a designated location; position a screw on to a seat provided at the workstation; and position the plastic bag on to the seat. In another example, the manufacturing operation record 114B includes five process elements 118B that provides that the operator: place a set of center rear cap (i.e., “#” number of rear cap) on to fasteners of the seat; place another set of center rear caps on to fasteners of the seat; obtain a designated number of center rear caps; open plastic bag having the center rear caps; and discard the plastic bag.

The manufacturing operation records 114 include process element data for each of the process elements 118A and 118B, where the process element data includes, but is not limited to: an element ID 122A, a textual description 122B of the respective process element, and a process time 122C, which is a predefined time. In the following, the process element data may be collectively referred to as “process element data 122.” The process database 106 may store other information related to the manufacturing operation and/or the process elements and should not be limited to the example of FIG. 3. For example, in addition to the manufacturing operation ID 120, the process database 106 stores an operation description for the manufacturing operations.

With continuance reference to FIG. 2, the domain variable database 108 is configured to store domain variable data for the plurality of manufacturing operations 114. Different manufacturing operations may be influenced by different domain variables. For example, a manufacturing operation that employs a tool is influenced by different domain variables than a manufacturing operation that does not employ a tool. Accordingly, in one form, the domain variable database 108 is configured to associate the domain variable data with related manufacturing operations. In one form, the process database 106 and the domain variable database 108 may be combined into one database.

In one form, the operation selection module 110 is configured to support the MD portal 102 and receive a request for a predicted operation time for a selected manufacturing operation having multiple process elements (PE-1 to PE-N). More particularly, via the MD portal 102, the operation selection module 110 provides the various manufacturing operations available for selection, and based on the selection by the user, the operation selection module 110 is configured to identify and retrieve the manufacturing operation record associated with selected manufacturing operation 114 from the process database 106. As provided above, the manufacturing operation record 114 includes the process element data 122 for the process elements 118 associated with the selected manufacturing operation 114. In addition to the manufacturing operation, the operation selection module 110 is configured to obtain one or more domain variable data from the domain variable database 108 associated with the selected manufacturing operation 114 based on inputs from via the MD portal 102. For example, once the user selects the manufacturing operation, the operation selection module 110 provides the domain variables associated with the manufacturing operation via the MD portal 102, which can be provided as predefined data selectable in a drop-down menu, data entered by the user, or a combination thereof.

The operation time module 111 is configured to determine a predicted operation time for the selected manufacturing operation 114 using the time prediction model 112 and based on the process element data 122 and in some variations, the domain variable data. The time prediction model 112 is a trained model recognizing sequential patterns among the plurality of process elements 118 for the selected manufacturing operation 114. In one form, various models and/or deep neural network methodologies may be employed to obtain the time prediction model 112 including, but not limited to: natural language models (e.g., bidirectional encoder representations from transformers (BERT)), long-short term memory (LSTM), full-connection layers, self-attention layers, bidirectional LSTM (BiLSTM), and/or XGBOOST. In one form, the time prediction model 112 is trained using historical data that includes, for a given manufacturing operation: the process element data 122 for the manufacturing operation, domain variable data defined for the manufacturing operation, a baseline operation time provided as the sum of the predefined process times, an adjusted operation time determined based on actual implemented workstation, work studies, and/or other suitable data. Using the historical data and machine learning techniques, the time prediction model 112 is trained to identify patterns between sequenced process elements and the effect those patterns have the operation time.

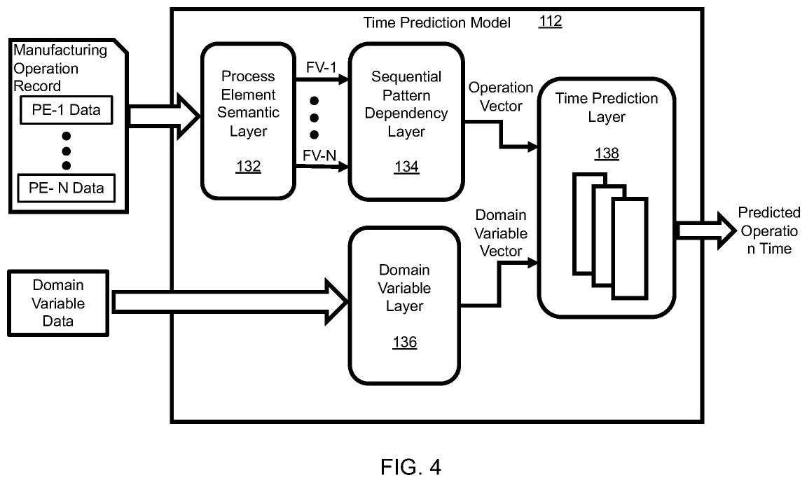

In one form, referring to FIG. 4, the time prediction model 112 generally includes a process element semantic layer 132, a sequential pattern dependency layer 134, a domain variable layer 136, and a time prediction layer 138. In one form, the process element semantic layer 132 is configured to parse the process element (PE) data for each of the process elements into one or more tokens (e.g., verb, object, number, etc.) to further determine a feature vector for the process element. More particularly, in one form, the process element semantic layer 132 is defined using a deep learning natural language model configured to understand written text that is parsed and tagged to determine the meaning of the text. For example, with regard to the textual description 122B of the process element data 122, the process element semantic layer 132 is configured to translate each word into a token or number (e.g., using workpiece tokenizer to split the text to words). Based on the tokens, the process element semantic layer 132 uses a language module (e.g., BERT language model) to extract one or more semantic relationships among tokens and defines a feature vector for the process element (e.g., FV-1 to FV-N for PE-1 Data to PE-N Data).

The sequential pattern dependency layer 134 is trained to identify sequential patterns of the feature vectors, where the sequential patterns affect the process time of the manufacturing operation 114. In one example, a sequential pattern is defined as one or more sequential relationships among at least two or more process elements. In one form, the sequential pattern dependency layer 134 is defined using known self-attention modeling to identify the sequential pattern. The sequential pattern dependency layer 134 is configured to generate an operation vector indicative of the selected manufacturing operation 114 based on the sequential patterns of the feature vectors.

In one form, the domain variable layer 136 is configured to correlate the domain variable data with a numerical value or vector. In one example, the domain variable layer 136 is configured to correlate each variable associated with the domain variable data with a numerical value or vector. In this example, the domain variable layer 136 may generate a domain variable vector based on a combined vector of one or more vectors of the variables of the domain variable data. In one form, the combined vector is based on a collection of vectors related to all of the variables associated with the domain variable data. In one form, the domain variable layer 136 is a separate layer that processes the domain variable data selected by the user. In another form, the domain variable layer 136 can be embedded in the sequential pattern dependency layer 134.

In one form, the time prediction layer 138 includes multiple hidden layers that are configured to determine the predicted operation time based on the operation vector of the selected manufacturing operation 114 and in some variations, the domain variable vector. In one form, the time prediction layer 138 employs known regression techniques to determine the predicted operation time for the manufacturing operation 114. In one form, the predicted operation time is provided to the user via the MD portal 102.

The time prediction model 112 is an adaptive prediction tool that takes into account the relationship of sequential process elements and domain variables to improve the accuracy of the predicted operation time for a manufacturing operation. With the time prediction model 112, design engineers may easily change or adjust characteristics of the workstation throughout the design process allowing improved flexibility and customization.

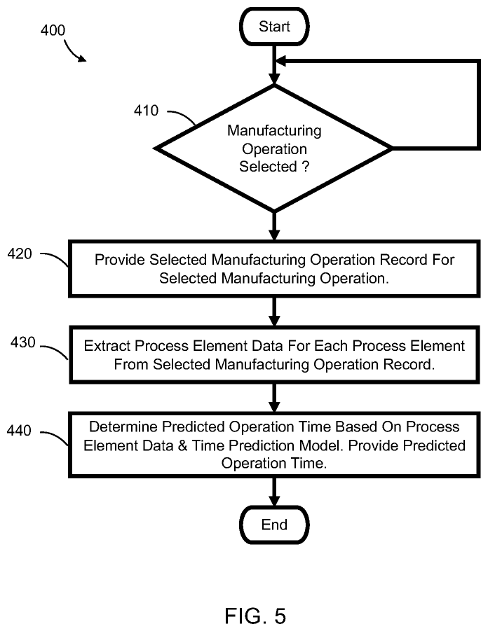

Referring to FIG. 5, an example manufacturing prediction routine 400 performed by the process allocation system of the present disclosure is provided. At 410, the process allocation system 104 determines if a manufacturing operation is selected and at 410 provides the manufacturing operation record for the selected manufacturing operation. For example, the process allocation system 104 identifies and obtains the selected manufacturing operation record from the process database 106 storing a manufacturing operation record for each manufacturing operation. At 430, the process allocation system 104 extracts the processing element data for a plurality of process elements associated with the selected manufacturing operation from the manufacturing operation record. At 440, the process allocation system 104 determines the predicted operation time for the selected manufacturing operation for the workstation based on the process element data 122 and the time prediction model 112, and provides or outputs the predicted operation time via, for example, the MD portal 102.

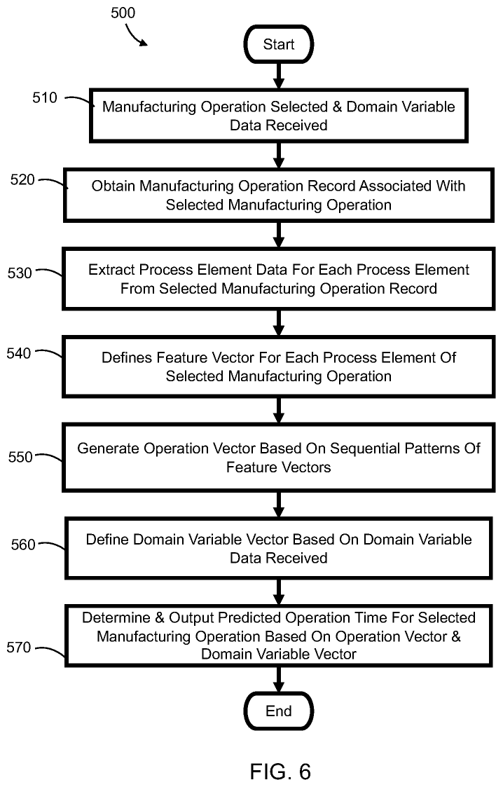

Referring to FIG. 6, a second example of a manufacturing prediction routine 500 is provided. At 510, the process allocation system 104 receives a selected manufacturing operation and domain variable data. For example, the system 104 receives the information via the MD portal 102. At 520, using the selected manufacturing operation, the process allocation system 104 obtains the manufacturing record associated with selected manufacturing operation. Like in routine 400, the process allocation system 104 extracts the processing element data for a plurality of process elements associated with the selected manufacturing operation from the manufacturing operation record, at 530. At 540, the process allocation system 104 defines a feature vector for each process element of the selected manufacturing operation. For example, the process allocation system 104 parses each term of the textual description for each process element into one or more tokens, extracts one or more semantic relationships of textual description based on token, and defines a feature vector for each process element based on the semantic relationship. At 550, with the sequential feature vectors, the process allocation system 104 generates an operation vector based on one or more sequential patterns of the feature vectors. At 560, the process allocation system 104 defines a domain variable vector based on the received domain variable data. For example, the domain variable data is associated with a numerical value which is used to define the domain variable At 570, the process allocation system 104 determines and outputs a predicted operation time for the selected manufacturing operation based on the operation vector and the domain variable vector.

It should be readily understood that routines 400 and 500 are example control routines and other control routines may be implemented.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of defining a manufacturing operation for a workstation, the method comprising:
providing a selected manufacturing operation record from among a plurality of manufacturing operation records, wherein the selected manufacturing operation record is indicative of a selected manufacturing operation to be executed in the workstation;
extracting, by a process allocation system, process element data for a plurality of process elements associated with the selected manufacturing operation record, wherein, for a respective process element among the plurality of process elements, the process element data includes a textual description of the respective process element and a process time; and
determining, by the process allocation system, a predicted operation time for the selected manufacturing operation based on the process element data and a time prediction model, wherein the time prediction model is a trained model recognizing sequential patterns among the plurality of process elements of the selected manufacturing operation.

2. The method of claim 1, wherein determining the predicted operation time further includes, for each of the plurality of process elements:
parsing, by the time prediction model, terms of the textual description of the respective process element into one or more tokens;
determining, by the time prediction model, semantic relationship of textual description based on tokens; and
defining, by the time prediction model, a feature vector for the respective process element based on the semantic relationship.

3. The method of claim 2 further comprising:
identifying, by the time prediction model, one or more sequential patterns of one or more feature vectors; and
generating, by the time prediction model, an operation vector indicative of the selected manufacturing operation based on the one or more sequential patterns of the one or more feature vectors, wherein the predicted operation time is determined based on the operation vector.

4. The method of claim 3, wherein the one or more sequential patterns of the one or more feature vectors is identified using self-attention modeling.

5. The method of claim 1 further comprising:
providing a domain variable data for the selected manufacturing operation,
wherein the domain variable data is indicative of a domain variable that influences time of the selected manufacturing operation, and
wherein the predicted operation time of the selected manufacturing operation is further determined based on the domain variable data.

6. The method of claim 5, wherein the domain variable data includes data indicative of a tool characteristic related to a tool to be employed at the workstation, a workstation characteristic, or a combination thereof.

7. The method of claim 1, wherein providing the selected manufacturing operation record from among the plurality of manufacturing operation records further includes identifying the selected manufacturing operation record in a database storing the plurality of manufacturing operation records based on the selected manufacturing operation, wherein the database stores the process element data for the plurality of process elements associated with the selected manufacturing operation.

8. A method of defining a manufacturing operation for a workstation, the method comprising:
providing a selected manufacturing operation record from among a plurality of manufacturing operation records and a domain variable data, wherein the selected manufacturing operation record is associated with a selected manufacturing operation to be executed in the workstation and the domain variable data is indicative of a domain variable that influences time of the selected manufacturing operation;
extracting, by a process allocation system, process element data for a plurality of process elements associated with the selected manufacturing operation from the selected manufacturing operation record, wherein, for a respective process element among the plurality of process elements, the process element data includes a textual description of the respective process element and a process time;
defining, by a time prediction model of the process allocation system, a feature vector for each of the plurality of process elements based on a semantic relationship of the textual description for the process element
identifying, by the time prediction model, one or more sequential patterns of the one or more feature vectors of the plurality of process elements; and
determining, by the time prediction model, a predicted operation time for the selected manufacturing operation based on the one or more sequential patterns of the one or more feature vectors and the domain variable data.

9. The method of claim 8, wherein the one or more sequential patterns of the one or more feature vectors are identified using the domain variable data.

10. The method of claim 8 further comprises correlating the domain variable data with a numerical value to define domain variable vector, wherein the predicted operation time for the selected manufacturing operation is determined based on the domain variable vector and the one or more sequential patterns of the one or more feature vectors.

11. The method of claim 8, wherein the domain variable data includes data indicative of a tool characteristic related to a tool to be employed at the workstation, a workstation characteristic, or a combination thereof.

12. The method of claim 8, wherein the sequential patterns of the one or more feature vectors is identified using self-attention modeling.

13. The method of claim 8, wherein providing the selected manufacturing operation from among a plurality of manufacturing operations further includes identifying the selected manufacturing operation record in a database storing the plurality of manufacturing operation records, wherein the database stores the process element data for the plurality of process elements associated with the selected manufacturing operation.

14. A system for designing a workstation at which a manufacturing operation is to be performed, the system comprising:
a database configured to store a plurality of manufacturing operation records for a plurality of manufacturing operations, wherein each of the manufacturing operations is defined by a plurality of process elements provided in sequence, each of the manufacturing operation records includes process element data for each of the plurality of process elements, wherein the process element data for a respective process element includes a textual description of the respective process element and a process time;
a processor; and
a nontransitory computer-readable medium including instructions that are executable by the processor, wherein the instructions include:
obtaining a selected manufacturing operation record from among the plurality of manufacturing operation records from the database for a selected manufacturing operation;
extracting the process element data from the select manufacturing operation record; and
determining a predicted operation time for the selected manufacturing operation based on the process element data and a time prediction model, wherein the time prediction model is a trained model recognizing sequential patterns among the plurality of process elements for the selected manufacturing operation.

15. The system of claim 14, wherein the instructions further includes, for each of the plurality of process elements of the selected manufacturing operation:
parsing, by the time prediction model, terms of the textual description of the process element data into one or more tokens;
determining, by the time prediction model, semantic relationship of textual description based on the one or more tokens; and
defining, by the time prediction model, a feature vector for the respective process element based on the semantic relationship.

16. The system of claim 15, wherein the instructions further includes:
identifying, by the time prediction model, one or more sequential patterns of one or more feature vectors; and
generating, by the time prediction model, an operation vector indicative of the selected manufacturing operation based on the one or more sequential patterns of the one or more feature vectors, wherein the predicted operation time is determined based on the operation vector.

17. The system of claim 16, wherein the one or more sequential patterns of the one or more feature vectors is identified using self-attention modeling.

18. The system of claim 14, wherein the instructions further includes:
obtaining a domain variable data for the selected manufacturing operation,
wherein the domain variable data is indicative of a domain variable that influences time of the selected manufacturing operation, and
wherein the predicted operation time of the selected manufacturing operation is further determined based on the domain variable data.

19. The system of claim 18, wherein the domain variable data includes information related to a tool to be employed at the workstation, a dimension of the workstation, an operation characteristic of the tool to perform the process element, or a combination thereof.

20. The system of claim 18, wherein the instructions further include correlating the domain variable data with a numerical value to define domain variable vector, wherein the predicted operation time for the selected manufacturing operation is determined based on the domain variable vector and the one or more sequential patterns of one or more feature vectors.
